(19) United States
(12) Patent Application Publication
(10) Pub. No.: US 2025/0036475 A1
(43) Pub. Date: Jan. 30, 2025

(54) GRANULAR MANAGEMENT OF PODS AND CONTAINERS

(71) Applicant: Dell Products L.P., Round Rock, TX (US)

(72) Inventors: IGOR DUBROVSKY, Beer Sheva (IL); BORIS SHPILYUCK, Ashdod (IL); NISAN HAIMOV, Beer Sheva (IL); MAXIM BALIN, Gan-Yavne (IL)

(21) Appl. No.: 18/359,490

(22) Filed: Jul. 26, 2023

(51) Int. Cl. G06F 9/50

(52) U.S. Cl. CPC G06F 9/505; G06F 9/5072

(57) ABSTRACT

Methods and systems for managing pods and containers that provide computer implemented services are disclosed. The pods and containers may be managed to improve efficiency of resource use and reduce exposure to threats to operation of systems that host the pods and containers. To ascertain how to manage the pods and containers, the pods and containers may be monitored and analyzed. The results of the monitoring and analyzation may be used to select how to change the pods and containers over time.

### FIELD

Embodiments disclosed herein relate generally to service management. More particularly, embodiments disclosed herein relate to systems and methods to components that provide services.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2B show diagrams illustrating data flows in accordance with an embodiment.

FIGS. 3A-3B show flow diagrams illustrating methods in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing pods and containers used to provide computer implemented services. To manage the pods and containers, the containers may be analyzed to ascertain whether containers of a pod are overutilized or underutilized. If the containers are overutilized or underutilized, the pod definitions and container definitions may be updated to improve the over/under utilization. Once updated, the containers may be automatically updated based on the definition thereby rightsizing the number and types of containers of pods.

Additionally, the containers may be monitored to identify undesirable containers. A container may be undesirable when it is inefficient, out of date, and/or present security risks. If such containers are identified, the pod and/or container definitions may be updated to replace the undesired containers with more desirable containers (e.g., that are more efficient, up to date, and/or present reduced levels of security risk).

By doing so, embodiments disclosed herein may improve the likelihood of desired computer implemented services being provided through improved efficiency of use of computing resources and reduced vulnerability to threats.

In an embodiment, a method for managing resources of a distributed system is provided. The method may include obtaining container operation metrics for pods hosted by the distributed system; for a pod of the pods, performing a workload analysis of containers of the pod obtain container level metrics for the pod; making a determination regarding whether to perform pod level of container level scaling based on the container level metrics for the pod; in a first instance of the determination where container level scaling for the pod is to be performed: updating a pod definition for the pod; updating container membership in the pod based on the pod definition to obtain an updated pod; and providing computer implemented services using the updated pod.

In a first instance of the updating of the pod definition where a container level metric of the container level metrics fell below a first workload threshold for a container of the containers: the pod definition is updated to specify at least one additional instance of the container.

In a second instance of the updating of the pod definition where the container level metric of the container level metrics fell below a second workload threshold for the container: the pod definition is updated to specify at least one less instance of the container.

Updating the container membership may include instantiating the at least one additional instance of the container or terminating operation of an instance of the container.

Making the determination may include comparing a first workload of a first container of the containers to a workload threshold to obtain a first comparison result; and comparing a second workload of a second container of the containers to the workload threshold to obtain a second comparison result.

Making the determination may also include, in a first instance where the first comparison result indicates that the workload threshold is exceeded and the second comparison result indicates that the workload threshold is not exceeded: concluding that container level scaling is to be performed.

Making the determination may also include in a first instance where the first comparison result indicates that the workload threshold is exceeded and the second comparison result indicates that the workload threshold is exceeded: concluding that pod level scaling is to be performed.

The method may also include, for a container of the containers, performing a performance analysis of the container to obtain a container performance rating; making a second determination regarding whether to the container performance rating indicates that the container is undesirable; in a first instance of the second determination where the container is undesirable: updating a pod definition for the pod to replace the container; updating the updated pod to replace the container using the pod definition to obtain a second updated pod; and providing the computer implemented services using the second updated pod.

The second determination may be based, at least in part, on a security state for the container.

The second determination may be based, at least in part, on an operating state for the container, the operating state being based on software component versions of the container.

In an embodiment, a non-transitory computer readable media (e.g., a machine readable medium) is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

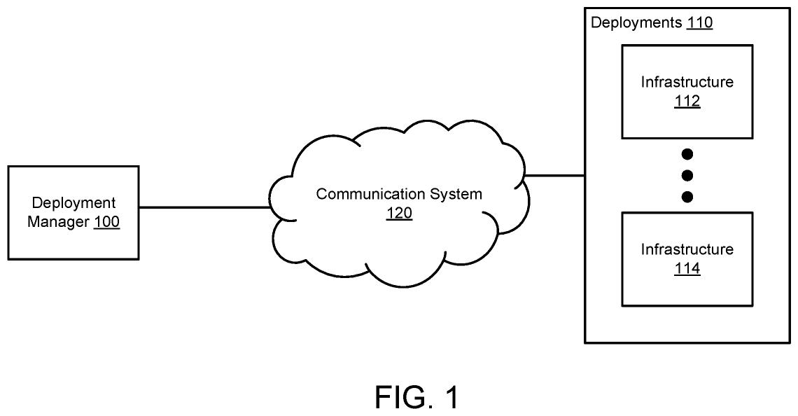

Turning to FIG. 1, a block diagram illustrating a system in accordance with an embodiment is shown. The system shown in FIG. 1 may provide computer-implemented services. The computer implemented services may include any type and quantity of computer implemented services. For example, the computer implemented services may include data storage services, instant messaging services, database services, and/or any other type of service that may be implemented with a computing device.

To provide the computer implemented services, the system of FIG. 1 may include deployments 110. A deployment may include collections of various infrastructure 112, 114. Infrastructure may include any number of data processing systems that may provide all or a portion of the computer implemented services (e.g., cooperatively and/or independently). Different infrastructure and deployments may provide similar or different computer implemented services.

To provide the computer implemented services, the infrastructure of deployment 110 may utilize layers of abstraction to manage provided computer implemented services. For example, the layers of abstraction may include pods and containers. A container may include various applications, and management services for the applications. The applications and management services may utilize some of the computing resources (e.g., processing resources, memory resources, storage resources, etc.) of the host infrastructure.

To utilize the resources, data processing systems of the infrastructure may host operating systems, and abstraction layers (e.g., such as a docker engine) that present some of these resources for use by corresponding containers. Groups of containers may be aggregated as a pod which may provide a type of computer implemented services. Different containers may provide various portions of the computer implemented services.

However, depending on how the computer implemented services are utilized, some of the containers of a pod may become resource constrained while other containers of a pod are not resource constrained. The resource constrained containers may negatively impact the services provided by the pod. For example, if a first container provide database services that are heavily utilized, while a second container provides instant messaging services that are underutilized, then the overall services (e.g., a platform level service) provided by the pod may be constrained by the rate at which the database services can be provided. For example, if a database managed by the first container is not updated quickly enough, the instant messaging services that draw information from the database may be negatively impacted (e.g., may not be up to date).

To address such constraints, instances of the pod may be scaled by instantiating additional pods that provide the same service with the load being balanced across the pods. The resulting scaled pods may eliminate the constriction imposed by one of the containers in the pod, but at the cost of dedicating additional resources to more instances of underused containers. Consequently, the efficiency of resource use for the computer implemented services provided by the pods may be reduced. For example, additional resources dedicated to the underutilized containers in the scaled pods may be further underutilized.

In general, embodiments disclosed herein may provide methods, systems, and/or devices for improving the efficiency of resource use in providing desired computer implemented services. To improve the efficiency of resource uses, the system of FIG. 1 may granularly scale out both containers and pods based on workloads imposed on different containers within pods.

To granularly scale both containers and pods, the system of FIG. 1 may track the workload of different containers within a pod. The workloads may be analyzed to identify containers within a pod that are constraining the pod as a whole and/or are underutilized. For such pods, the pod definition may be updated to include additional instances of overutilized containers and fewer instances of underutilized containers. By doing so, resources allocated across pods may be granularly updated to reduce the likelihood of the performance of pods being limited by resource constrained containers and resource consumption by underutilized containers that do not provide any benefit to the computer implemented services provided by the pod.

Additionally, the system of FIG. 1 may track the performance and operating conditions of containers to identify undesirable containers. A container may become undesirable when (i) its performance falls below that of other containers providing similar services, (ii) become outdated (e.g., utilizes out of date applications/management services), and/or (iii) present security risks. By tracking the performance of the containers, such undesirable containers may be identified and replaced over time.

To provide the above noted functionality, the system of FIG. 1 may include deployment manager 100, deployments 110, and communication system 120. Each of these components is discussed below.

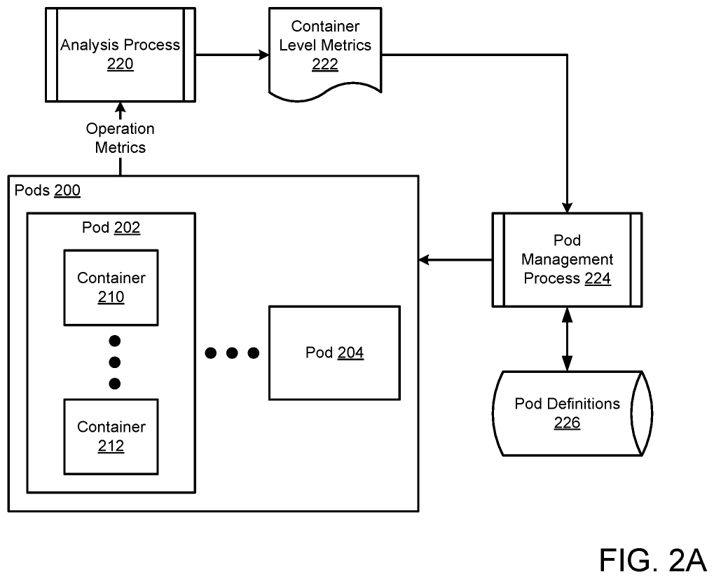

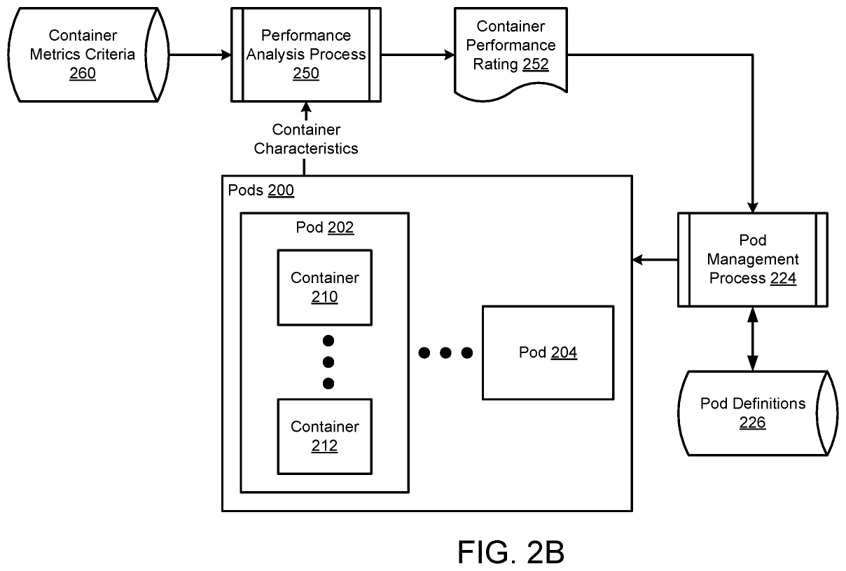

Deployment manager 100 may manage pods deployed to deployments 110. To do so, deployment manager 100 may (i) granularly track the performance and condition of containers of the pods, and (ii) update the definitions of pods based on the tracked performance and conditions of the containers of the pods. Refer to FIGS. 2A-2B for additional details regarding management of vulnerabilities.

Deployments 110 may include any number of collections of infrastructure 112-114. The deployments may provide various computer implemented services. Different infrastructure may include different types of data processing systems having different components and/or conditions impacting the components.

To facilitate provisioning of computer implemented services, the data processing systems may host (i) abstraction frameworks to facilitate execution of pods and containers, (ii) monitoring frameworks to monitor the performance and condition of containers, and (iii) automation frameworks to update the instances of pods and containers overtime based on pod definitions. Refer to FIGS. 2A-2B for additional details regarding providing of computer implemented services using containers and pods.

While illustrated as being separate from deployments 110, the functionality of deployment manager 100 may be performed by any of the components of deployments 110. For example, deployment manager 100 may be implemented using a distributed management framework. The management framework may perform the functionality of deployment manager 100, discussed herein.

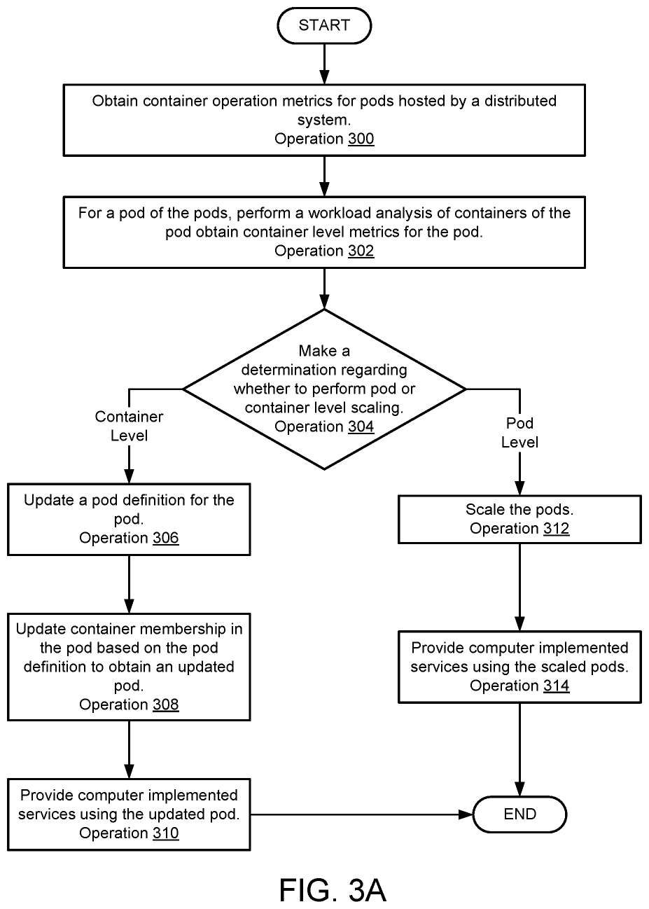

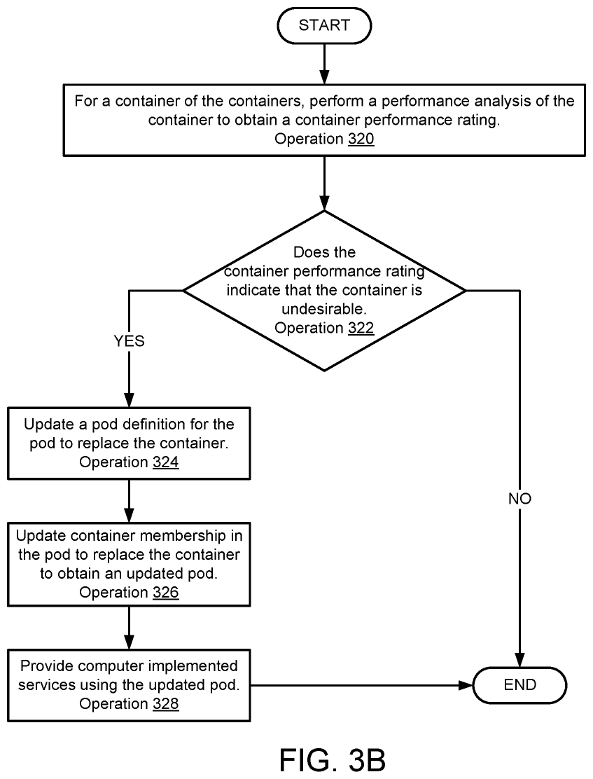

When providing their functionality, any of deployment manager 100 and deployments 110 may perform all, or a portion, of the methods illustrated in FIGS. 3A-3B.

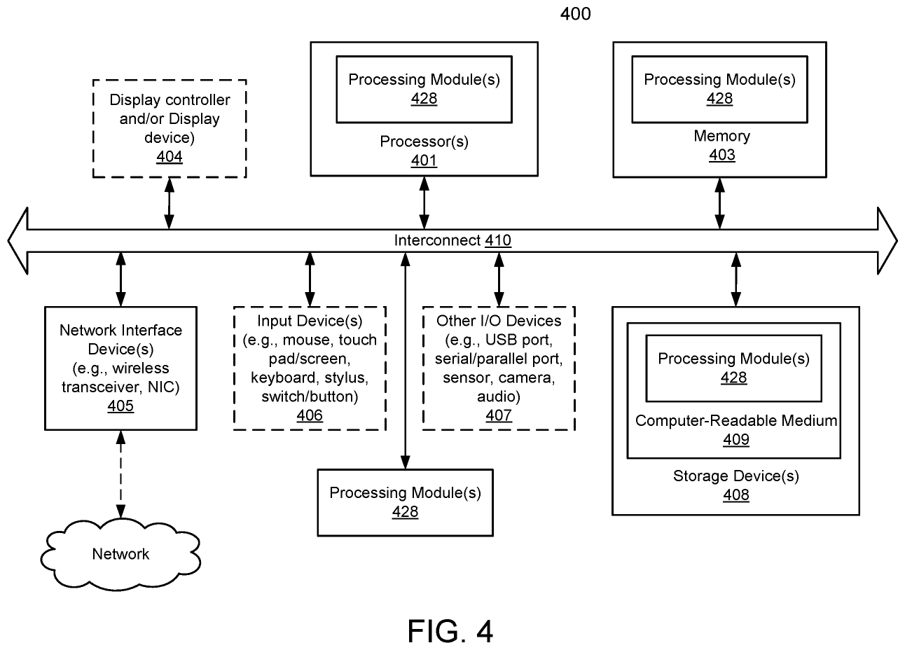

Any of deployment manager 100 and deployments 110 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 120. In an embodiment, communication system 120 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

As discussed above, deployment manager 100 may facilitate management of infrastructure. FIGS. 2A-2B show data flow diagrams in accordance with embodiments that illustrate data flows that may occur while computer implemented services are provided usings pods and containers. In FIGS. 2A-2B, a first set of shapes (e.g., 222) is used to represent data structures, a second set of shapes (e.g., 220) is used to represent processes performed using data, and a third set of shapes (e.g., 226) is used to represent large scale data structures such as databases.

Turning to FIG. 2A, a first data flow diagram illustrating data flows, data processing, and/or other operations that may be performed by the system of FIG. 1 in accordance with an embodiment is shown. The first data flow diagram may illustrate data flows that may occur while pods 200 provide computer implemented services.

To provide the computer implemented services, pods 200 may include any number of pods (e.g., 202-204). Each of the pods may host similar and/or different numbers and types of containers (e.g., 210-212).

To manage operation of pods 200, pod management process 224 may be performed. During pod management process 224, the operation of pods 200 may be updated over time by (i) instantiating and/or terminating pods, and (ii) instantiating and/or terminating containers of pods. The pods and containers may be instantiated/terminated based on pod definitions 226.

Pods definitions 226 may be implemented using a data structure the specifies the numbers and types of pods and containers to be maintained. Pod management process 224 may monitor pods 200 for compliance with pods definitions 226, and may take action to return pods 200 to compliance with pods definitions 226.

Additionally, pods management process 224 may update pod definitions 226 over time based on container level metrics 222. Container levels metrics 222 may indicate whether containers of pods are over utilized (e.g., based on comparisons of workload levels to thresholds) or underutilized.

If some containers of a pod are overutilized or other containers of pods are underutilized, pod management process 224 may implement container level scaling by updating the definition for the pod to increase numbers of overused containers and/or decreasing numbers of underused containers in a pod. Once updated, operation of pods 200 may be updated accordingly. In contrast, if all containers are overutilized or underutilized, then pod level scaling may be implemented by increasing the number of instances of a pod or decreasing the number of instance of a pod, respectively.

To ascertain whether a container is over or underutilized, analysis process 220 may be performed. During analysis process 220, the operation of containers of pods 200 may be monitored. Specifically, the containers may be monitored to identify whether the containers are using more or less than a prescribed quantity (e.g., a threshold level) of the computing resources allocated to each container. Container level metrics 222 may be populated with information based on the comparison. For example, containers that are using a greater quantity than the prescribed quantity of computing resources may be ascribed as being overutilized in container level metrics 222.

The monitoring of the containers may be performed periodically over time, continuously, at sampled periods of time, in response to occurrence of certain events, and/or under other conditions. To perform the monitoring, abstraction frameworks (not shown) may be queried. The abstraction frameworks that provide access to certain computing resources may keep track of the user rates of the computing resources provided to each container.

To ascertain whether to perform scaling, pod management process 224, may ingest container level metrics 222. During ingestion, the metrics (e.g., over/under utilization, extent of the over/under utilization, etc.) for containers of a pod may be used to analyze an impact on a corresponding pod. For example, the metrics for each container may be used in conjunction with dependencies of each of the containers on one another (e.g., may be defined by pod definitions 226).

The dependencies may be used to identify which containers depend on the operation of other containers. If a first container depends on the operation of a second container, and the first container is underutilized but the second container is overutilized, the pod definition may only be updated to increase the number of instances of the second container (e.g., because the underutilization of the first container may be due to the over utilization of the second container as opposed to lack of utility). In contrast, if the first container does not depend on the operation of the second container, and the first container is underutilized but the second container is overutilized, then the pod definition may only be updated to increase the number of instances of the second container and decrease the number of instances of the first pod definition.

In this manner, the number of instances of containers and pods may be granularly scaled to eliminate bottlenecks and reduce resource allocations that do not contribute to services provided by the pods.

Turning to FIG. 2B, a second data flow diagram illustrating data flows, data processing, and/or other operations that may be performed by the system of FIG. 1 in accordance with an embodiment is shown. The second data flow diagram may illustrate data flows that may occur while pods 200 provide computer implemented services.

To provide the computer implemented services, as discussed above, pods 200 may include various containers 210-212 that are managed by pod management process 224. However, overtime any of the containers may (i) become inefficient due to bloat, (ii) become outdated due to older definitions in pod definitions 226, and/or (iii) present security threats due to out of date threat management capabilities. To reduce the impact of such threats on the computer implemented services provided by pods 200, performance analysis process 250 may be performed.

During performance analysis process 250, the operation of containers of pods and condition of the pods may be monitored (e.g., by obtaining container characteristics) and analyzed to determine whether any of the containers have become undesired. To ascertain whether a container has been undesirable, its performance, components, and threat profile may be analyzed.

To analyze the performance of a container, the rate at which the container provides services and quantity of computing resources consumed to provide the services may be compared to corresponding thresholds. The thresholds may be set by other containers providing similar services (e.g., through averaging of the performance of containers, and/or other statistical characterizations). Such information may be included in container metrics criteria 260, which may be updated over time based on the actual performance of containers across pods 200. If a container's rate and/or resource consumption is outside corresponding ranges established based on the operation of peer containers, then the container may be rated as being undesirable.

To analyze the components of a container, the components (e.g., versions of software, configurations, etc.) may be compared to components of other containers that provide similar services. For example, the other containers may include similar software components but of varying version number or release. The version number/release may be averaged to identify an average version number or release. The variation may also be statistically analyzed to identify the standard of deviation. If the version/release of the software components of a container fall outside of one standard deviation from the average, then the container may be rated as being undesirable.

To analyze the threat profile of a container, the components (e.g., versions of software, configurations, versions/capabilities of threat counter measures such as anti-virus software/secure boot status/etc.) may be compared to similar threat counter measures of other containers that provide similar services. For example, the other containers may include various threat counter measures. The threat counter measures may be statistically analyzed to identify acceptable ranges and types of threat counter measures of an average container. If the threat counter measures of a container fall outside of the average threat counter measures of the average container, then the container may be rated as being undesirable.

Container performance rating 252 may be populated based on these three separate analysis and corresponding results. Once obtained, container performance rating 252 may be ingested by pod management process 224. Pod management process 224 may analyze container performance rating 252 to decide whether to terminate container instances and/or replace the terminated container instances (e.g., with more up to date instances of the terminated container). For example, if any of the analysis return a rating of undesirable, then pod management process 224 may initiate replacement of the container.

To replace the container, pod management process 224 may update pod definitions to replace the definition for the container with an updated definition. Once updated, the container may automatically be terminated and replaced with a corresponding updated instance of the container.

In some cases, the container may be replaced with increased or decreased numbers of instances. For example, more up to date containers may be able to provide the functionality of more or fewer of the previous instance of the container. Consequently, when replacing container definitions, capacity estimates for new and/or old versions of definitions for the containers may be used to ascertain the number and type of containers instances to create as replacements for terminated instances of containers.

Further, overtime new versions of containers may expand or contract the functionality of a given container. Such changes between versions of containers may be documents (e.g., in pod definitions), and may be used to update the pod definitions so that equivalent functionality is maintained. Consequently, when an existing container definition for a pod definition is removed from pod definitions, more or fewer numbers of similar and/or different container definitions may be added to ensure that replacement functionality for the terminated instances of the containers is put in place.

Thus, using the data flows shown in FIGS. 2A-2B, embodiments disclosed herein may granularly scale containers and pods, depending on how containers and pods are utilized (e.g., over/under), thereby reducing allocation of otherwise wasted resources and removing constrictions that limit the rate at which computer implemented services are provided by the pods. Further, by updating the containers of pods dynamically over time, undesirable containers may be automatically removed.

As discussed above, the components of FIG. 1 may perform various methods to manage operation of infrastructure through identification and management of vulnerabilities that may be exhibited depending on conditions present in the infrastructure. FIGS. 3A-3B illustrate methods that may be performed by the components of the system of FIG. 1. In the diagram discussed below and shown in FIGS. 3A-3B, any of the operations may be repeated, performed in different orders, and/or performed in parallel with or in a partially overlapping in time manner with other operations.

Turning to FIG. 3A, a first flow diagram illustrating a method for managing pods and containers in accordance with an embodiment is shown. The method may be performed by any of deployment manager 100, deployments 110, and/or other components of the system shown in FIG. 1.

At operation 300, container operation metrics for pods hosted by a distributed system are obtained. The container operation metrics may be obtained by monitoring use of allocated resources by the containers.

At operation 302, for a pod of the pods, a workload analysis of the containers of the pod is performed to obtain container level metrics for the pod. The workload analysis may be performed by comparing the monitored use of allocated resources for each container to corresponding thresholds that define when over or under use of the allocated resources exists. The thresholds may be defined, for example, by a subject matter expert or in an automated manner (e.g., through analysis of use of allocated resources by peer containers). The resulting container level metrics may specify whether each container of the pod is over or underutilized.

At operation 304, a determination is made regarding whether to perform pod or container level scaling. The determination may be made using the container level metrics. If some of the containers are listed as underutilized and others are listed as being over utilized, then container level scaling may be selected for performance. In contrast, if all of the containers are listed as under or over utilized, then pod level scaling may be performed.

If container level scaling is selected for performance, then the method may proceed to operation 306 following operation 304. Otherwise, the method may proceed to operation 312.

At operation 306, a pod definition for the pod is updated. The pod definition may be updated by adding or removing container definitions. For example, for overutilized containers, additional container definitions for the overutilized containers may be added.

For the underutilized container, the dependency of the underutilized containers may be analyzed. If no dependencies on the overutilized containers exist, then container definitions for the underutilized containers may be reduced in the pod definition. If some dependencies exist, then the container definitions for the corresponding underutilized containers may not be changed.

At operation 308, the container membership in the pod is updated based on the pod definition to obtain an updated pod. The container membership may be automatically updated by virtue of the pods being automatically updated to conform to the pod definition. For example, existing container instances may be automatically terminated and/or new instances of containers may be generated to conform the operation of the pod to the pod definition.

At operation 310, computer implemented services are provided using the updated pod. The updated pod may automatically do so by virtue of its operation.

The method may end following operation 310.

Returning to operation 304, the method may proceed to operation 312 following operation 304 if pod level scaling is selected.

At operation 312, the pod is scaled. The pod may be scaled by removing instances of the pod and/or instantiated new copies of the pod. The pod may be scaled by updating pod definitions accordingly, which may be automatically implemented over time.

At operation 314, the computer implemented services are provided using the scaled pods.

The method may end following operation 314.

Thus, using the method shown in FIG. 3A, a system in accordance with an embodiment may automatically remove constrictions in operation and free misallocated resources of pods.

Turning to FIG. 3B, a second flow diagram illustrating a method for managing pods and containers in accordance with an embodiment is shown. The method may be performed by any of deployment manager 100, deployments 110, and/or other components of the system shown in FIG. 1.

At operation 320, for a container of containers of a pod, a performance analysis for the container may be performed to obtain a container performance rating. The performance analysis may be performed by (i) identifying and comparing the efficiency of use of resources by the container to efficiencies of peer containers, (ii) identifying and comparing components of the container to peer containers, and (iii) identifying and comparing the security state of the container to security states of peer containers. Refer to FIG. 2B for additional details regarding these identifications and comparison.

The resulting container performance rating may specify multiple performance ratings related to efficiency, outdatedness, and security of the container (e.g., rated as being acceptable or unacceptable).

At operation 322, a determination is made regarding whether the container performance rating indicates that the container is undesirable. The container performance rating may indicate that the container is undesirable if the container is rated as unacceptable for one or more of the ratings specified by the container performance rating.

If the container is undesirable, then the method may proceed to operation 324. Otherwise, the method may end following operation 322.

At operation 324, a pod definition for the pod is updated to replace the pod container. The pod definition may be replaced similar to that discussed with respect to FIG. 2B.

At operation 326, the container membership in the pod may be updated to replace the container to obtain an updated pod. The container membership may be automatically updated through automated termination/instantiation of pods based on the updated pod definition.

At operation 328, computer implemented services are provided using the updated pod. The updated pod may automatically do so by virtue of its operation.

The method may end following operation 328.

Thus, via the method shown in FIG. 3B, a system in accordance with an embodiment may automatically replace undesirable containers.

Any of the components illustrated in FIGS. 1-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing resources of a distributed system, the method comprising:
obtaining container operation metrics for pods hosted by the distributed system;
for a pod of the pods, performing a workload analysis of containers of the pod obtain container level metrics for the pod;
making a determination regarding whether to perform pod level of container level scaling based on the container level metrics for the pod;
in a first instance of the determination where container level scaling for the pod is to be performed:
updating a pod definition for the pod;
updating container membership in the pod based on the pod definition to obtain an updated pod; and
providing computer implemented services using the updated pod.

2. The method of claim 1, wherein in a first instance of the updating of the pod definition where a container level metric of the container level metrics fell below a first workload threshold for a container of the containers:
the pod definition is updated to specify at least one additional instance of the container.

3. The method of claim 2, wherein in a second instance of the updating of the pod definition where the container level metric of the container level metrics fell below a second workload threshold for the container:
the pod definition is updated to specify at least one less instance of the container.

4. The method of claim 3, wherein updating the container membership comprises instantiating the at least one additional instance of the container or terminating operation of an instance of the container.

5. The method of claim 1, wherein making the determination comprises:
comparing a first workload of a first container of the containers to a workload threshold to obtain a first comparison result; and
comparing a second workload of a second container of the containers to the workload threshold to obtain a second comparison result.

6. The method of claim 5, wherein making the determination further comprises:
in a first instance where the first comparison result indicates that the workload threshold is exceeded and the second comparison result indicates that the workload threshold is not exceeded:
concluding that container level scaling is to be performed.

7. The method of claim 6, wherein making the determination further comprises:
in a first instance where the first comparison result indicates that the workload threshold is exceeded and the second comparison result indicates that the workload threshold is exceeded:
concluding that pod level scaling is to be performed.

8. The method of claim 1, further comprising:
for a container of the containers, performing a performance analysis of the container to obtain a container performance rating;
making a second determination regarding whether to the container performance rating indicates that the container is undesirable;
in a first instance of the second determination where the container is undesirable:
updating a pod definition for the pod to replace the container;
updating the updated pod to replace the container using the pod definition to obtain a second updated pod; and
providing the computer implemented services using the second updated pod.

9. The method of claim 8, wherein the second determination is based, at least in part, on a security state for the container.

10. The method of claim 8, wherein the second determination is based, at least in part, on an operating state for the container, the operating state being based on software component versions of the container.

11. A non-transitory machine-readable medium having instructions stored therein, which when executed by a processor, cause the processor to perform operations for managing resources of a distributed system, the operations comprising:
obtaining container operation metrics for pods hosted by the distributed system;
for a pod of the pods, performing a workload analysis of containers of the pod obtain container level metrics for the pod;
making a determination regarding whether to perform pod level of container level scaling based on the container level metrics for the pod;
in a first instance of the determination where container level scaling for the pod is to be performed:
updating a pod definition for the pod;
updating container membership in the pod based on the pod definition to obtain an updated pod; and
providing computer implemented services using the updated pod.

12. The non-transitory machine-readable medium of claim 11, wherein in a first instance of the updating of the pod definition where a container level metric of the container level metrics fell below a first workload threshold for a container of the containers:
the pod definition is updated to specify at least one additional instance of the container.

13. The non-transitory machine-readable medium of claim 12, wherein in a second instance of the updating of the pod definition where the container level metric of the container level metrics fell below a second workload threshold for the container:
the pod definition is updated to specify at least one less instance of the container.

14. The non-transitory machine-readable medium of claim 13, wherein updating the container membership comprises instantiating the at least one additional instance of the container or terminating operation of an instance of the container.

15. The non-transitory machine-readable medium of claim 11, wherein making the determination comprises:
comparing a first workload of a first container of the containers to a workload threshold to obtain a first comparison result; and
comparing a second workload of a second container of the containers to the workload threshold to obtain a second comparison result.

16. A data processing system, comprising:
a processor; and
a memory coupled to the processor to store instructions, which when executed by the processor, cause the processor to perform operations for managing resources of a distributed system, the operations comprising:
obtaining container operation metrics for pods hosted by the distributed system;
for a pod of the pods, performing a workload analysis of containers of the pod obtain container level metrics for the pod;
making a determination regarding whether to perform pod level of container level scaling based on the container level metrics for the pod;
in a first instance of the determination where container level scaling for the pod is to be performed:
updating a pod definition for the pod;
updating container membership in the pod based on the pod definition to obtain an updated pod; and
providing computer implemented services using the updated pod.

17. The data processing system of claim 16, wherein in a first instance of the updating of the pod definition where a container level metric of the container level metrics fell below a first workload threshold for a container of the containers:
the pod definition is updated to specify at least one additional instance of the container.

18. The data processing system of claim 17, wherein in a second instance of the updating of the pod definition where the container level metric of the container level metrics fell below a second workload threshold for the container:
the pod definition is updated to specify at least one less instance of the container.

19. The data processing system of claim 18, wherein updating the container membership comprises instantiating the at least one additional instance of the container or terminating operation of an instance of the container.

20. The data processing system of claim 16, wherein making the determination comprises:
comparing a first workload of a first container of the containers to a workload threshold to obtain a first comparison result; and
comparing a second workload of a second container of the containers to the workload threshold to obtain a second comparison result.
